(19) United States
(12) Patent Application Publication
(10) Pub. No.: US 2003/0205305 A1
(43) Pub. Date: Nov. 6, 2003

(54) Pneumatic tire

(76) Inventors: Masatoshi Kuwajima, Hiratsuka-shi (JP); Tetsuya Kuze, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/422,783

(22) Filed: Apr. 25, 2003

(30) Foreign Application Priority Data
Apr. 30, 2002 (JP) JP2002-128435

(51) Int. Cl. B60C 11/12; B60C 115/00

(52) U.S. Cl. 152/209.18; 152/209.28

(57) ABSTRACT

A pneumatic tire is disclosed in which ABS braking performance on a wet road after being worn is improved. This pneumatic tire includes: a tread pattern whose rotational direction is specified; and a block plotted on a tread by main grooves extending in a tire circumferential direction and lateral grooves extending in a tire width direction, the block having a pair of opposing corners with acute angles and including at least one sipe therein. In the pneumatic tire, a length of the sipe is made gradually longer from a tread surface toward a sipe bottom part and, assuming that the block is equally divided by a boundary of a straight line parallel to the tire circumferential direction into a region U where a corner of the block in the trailing side has an acute angle and a region L where a corner of the block in the leading side has an acute angle, edge lengths L_{U}, L_{L} of the block measured along the main groove in the regions U, L, and distances 1_{U}, 1_{L} from corners of the block in the trailing side to an opening end of the sipe bottom part measured in the regions U, L are set in relations of 0.4≦l_{L}/L_{L}≦0.8, 0.2≦l_{U}/L_{U}≦0.6, l_{L}/L_{L}≧l_{U}/L_{U}.

### BACKGROUND OF THE INVENTION

The present invention relates to a pneumatic tire suitable for a vehicle equipped with an antilock braking system (ABS), and more particularly to a pneumatic tire designed to improve ABS braking performance on a wet road after being worn.

In the pneumatic tire, it is known that an edge effect (an effect of cutting a thin water film on a road surface) is increased by disposing a sipe in a block plotted on a tread, and accordingly ABS braking performance is improved on the wet road. In such the pneumatic tire, when wearing of the tread progresses, while the edge effect of the sipe is almost unchanged, block rigidity is increased by rubber deterioration or a reduced block height to cause a problem of a reduction in the ABS braking performance on the wet road.

As a technology regarding the sipe, there is a technology for increasing an exposed length of the sipe following the progress of wearing by making a sipe contour of a bottom part different from that on a tread surface. However, in the pneumatic tire having a tread pattern whose rotational direction is specified, a pair of opposing corners in the block is generally acute. Consequently, if a sipe contour is excessively changed, the block rigidity is locally reduced, which causes inconveniences such as incapability of obtaining good ABS braking performance and easy occurrence of block breaking-off.

### SUMMARY OF THE INVENTION

An object of the present invention is to provide a pneumatic tire, which enables improvement of ABS braking performance on a wet road after being worn.

To achieve the object described above, the pneumatic tire of the present invention includes a tread pattern whose rotational direction is specified, and a block plotted on a tread by main grooves extending in a tire circumferential direction and lateral grooves extending in a tire width direction, the block having a pair of opposing corners with acute angles and including at least one sipe therein. In the pneumatic tire, a length of the sipe is made gradually longer from a tread surface toward a sipe bottom part and, assuming that the block is equally divided by a boundary of a straight line parallel to the tire circumferential direction into a region U where a corner of the block in the trailing side has an acute angle and a region L where a corner of the block in the leading side has an acute angle, edge lengths L_{U}, L_{L} of the block respectively measured along the main groove in the regions U, L, and distances l_{U,} l_{L} from corners of the block in the trailing side to an opening end of the sipe bottom part respectively measured in the regions U, L are set in relations of 0.4≦l_{L}/L_{L}≦0.8, 0.2≦l_{U}/L_{U}≦0.6, l_{L}/L_{L} ≧l_{U}/L_{U}.

As described above, when the sipe length is made gradually longer from the tread surface to the sipe bottom part, and assuming that the block is equally divided into the region U where the corner of the block in the trailing side has the acute angle and the region L where the corner of the block in the leading side has the acute angle, the edge lengths L_{U}, L_{L} of the block and the distances _{U}, 1_{L} from the corners of the block in the trailing side to the opening end of the sipe bottom part are set in the relations of 0.4≦l_{L}/L_{L}≦0.8, 0.2≦l_{U}/L_{U}≦0.6, l_{L}/L_{L}≧l_{U}/L_{U}. Thus, in the pneumatic tire including the tread pattern whose rotational direction is specified, even if the block in which the sipe is formed has the acute corners, a reduction in block rigidity can be avoided. Therefore, ABS braking performance on a wet road after being worn can be improved with an occurrence of block breaking-off prevented.

According to the present invention, at least one of an average distance X_{U} between a contour line of the sipe bottom part projected on the tread surface and a contour line of a sipe upper edge part in the region U, and an average distance X_{L} between the contour line of the sipe bottom part projected on the tread surface and the contour line of the sipe upper edge part in the region L is set to more than 0 mm, more preferably, to 7% or more of edge lengths (L_{U}, L_{L}) of the block.

### BRIEF DESCRIPTION OF THE DRAWINGS

FIG. 1 is a plan view showing a tread pattern of a pneumatic tire according to an embodiment of the present invention.

FIG. 2 is a plan view of a block in the present invention seen from a tire tread surface.

FIG. 3 is a perspective view showing the block in the present invention.

FIG. 4 is a plan view showing a modified example of the block in the present invention.

### DETAILED DESCRIPTION OF THE PREFERRED EMBODIMENTS

Next, a constitution of the present invention will be described in detail with reference to the accompanying drawings.

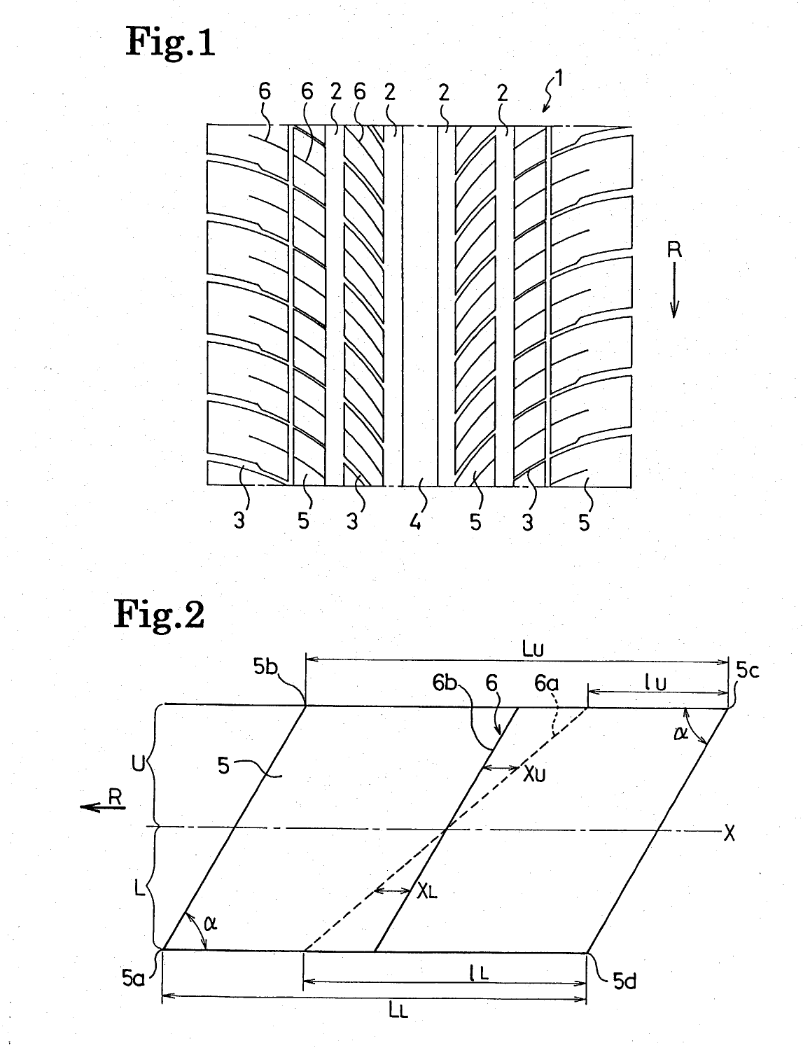

FIG. 1 shows a tread pattern of a pneumatic tire of an embodiment of the present invention. In this tread pattern, a rotational direction R is specified. In FIG. 1, a tread 1 includes a plurality of main grooves 2 extending in a tire circumferential direction, and a plurality of lateral grooves 3 extending in a tire width direction. More specifically, each lateral groove 3 extends in the tire width direction inclining from a tread center toward a shoulder in an opposite direction to the rotational direction R. By the main grooves 2 and the lateral grooves 3, a rib 4 is plotted on the tread center and extended in the tire circumferential direction, and a plurality of blocks 5 are plotted in both sides of the rib 4.

In each block 5, a sipe 6 having a width of 1.5 mm or lower is formed and extended in parallel with the lateral groove 3. This sipe 6 is not always necessary in all of the blocks 5. However, it is advisable to dispose as many sipes as possible in the block 5. Additionally, a plurality of sipes 6 may be disposed in each block 5.

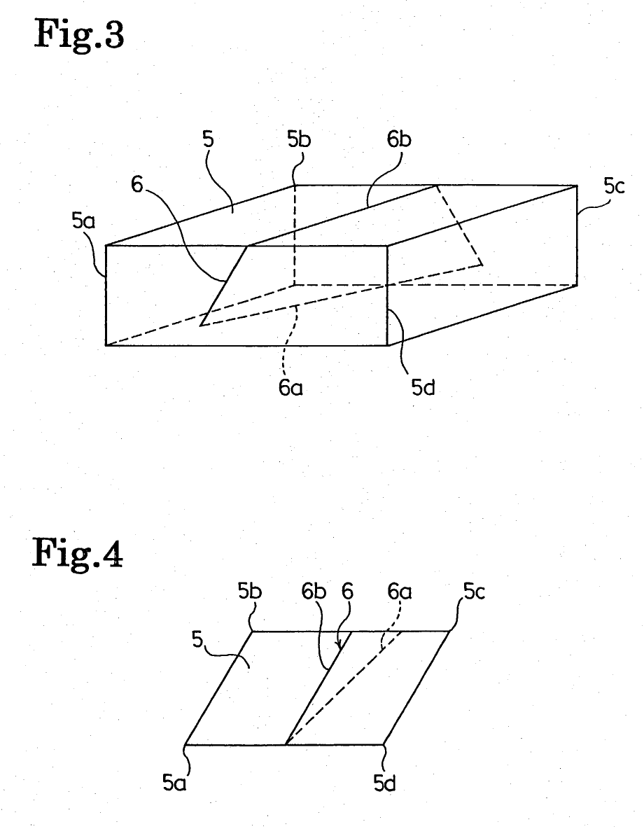

FIG. 2 is a plan view of the block of the present invention seen from a tire tread surface, and FIG. 3 is a perspective view thereof. As shown in FIG. 2, in the block 5, one pair of opposing corners 5a, 5c have acute angles and the other opposing corners 5b, 5d have obtuse angles, roughly forming a parallelogram. Angles α of the corners 5a, 5c are 10° to 80°. On the other hand, the sipe 6 has a contour twisted to the acute corners 5a, 5c from the tread surface toward the sipe bottom part, and has a length made gradually longer from the tread surface toward the sipe bottom part. By making the length of the sipe 6 gradually longer from the tread surface toward the sipe bottom part, an exposed length of the sipe 6 is increased as wearing of the tread 1 progresses. Thus, it is possible to improve ABS braking performance on the wet road after being worn.

Assuming that the block 5 is equally divided, by a boundary of a straight line X parallel to the tire circumferential direction, into a region U where the corner 5c at a trailing side (a rear side of the rotational direction R) has an acute angle and a region L where the corner 5a at a leading side (a front side of the rotational direction R) has an acute angle, at least one or, more preferably, both of an average distance X_{U} between a contour line 6a of the sipe bottom part projected on the tread surface and a contour line 6b of the sipe upper edge part in the region U and an average distance X_{L} between the contour line 6a of the sipe bottom part projected on the tread surface and the contour line 6b of the sipe upper edge part in the region L are set to more than 0 mm, more preferably, to 7% or more of edge lengths (L_{U}, L_{L}) of the block 5. By setting the average distances X_{U}, X_{L} to 7% or more of the edge lengths (L_{U}, L_{L}) of the block 5, the ABS braking performance on the wet road can be improved more surely. The average distances X_{U}, X_{L} can be calculated from values obtained by dividing areas of portions enclosed between the contour line 6a of the sipe bottom part projected on the tread surface and the contour line 6b of the sipe upper edge part in the regions U, L by widths of the regions U, L. The contour lines 6a, 6b may be straight or curved.

The edge lengths L_{U}, L_{L} of the block 5 respectively measured along the main groove 2 in the regions U, L, and distances 1_{U}, 1_{L} from the corners 5c, 5d of the block in the trailing side to an opening end of the sipe bottom part respectively measured in the regions U, L satisfy the following relations:

0.4≦l_{L}/L_{L}≦0.8

0.2≦l_{U}/L_{U}≦0.6

l_{L}/L_{L}≧l_{U}/L_{U}

That is, when the length of the sipe 6 is made gradually longer toward the sipe bottom part as described above, unless l_{L}/L_{L} and l_{U}/L_{U} satisfy the above relations, an edge length necessary for the block 5 cannot be secured. Thus, satisfactory braking performance cannot be obtained. Additionally, unless l_{L}/L_{L} and l_{U}/L_{U} satisfy the above relations, the block rigidity is reduced in a vicinity of the acute corners 5a, 5c to increase the floating amount of the block end due to a shearing force during braking. Thus, satisfactory braking performance cannot be obtained. As a result, a reduction in the ABS braking performance on the wet road after being worn cannot be suppressed. Also, unless l_{L}/L_{L} and l_{U}/L_{U} satisfy the above relations, breaking-off of the block easily occurs to worsen uneven wear resistance.

In other words, satisfaction of the above relations l_{L}/L_{L} and l_{U}/L_{U} enables exhibition of good braking performance on the wet road even after being worn in the automobile equipped with the ABS, and prevention of occurrence of block breaking-off.

According to the present invention, when the sipe length is made gradually longer from the tread surface toward the sipe bottom part, a sipe structure is not limited to the aforementioned embodiments. For example, a sipe structure similar to that of FIG. 4 may be employed. Additionally, there are no particular limitations on the tread pattern as long as the rotational direction is specified.

### EXAMPLE

Regarding a pneumatic tire having a size of 205/65R15 94H and a tread pattern with a specified rotational direction, in which one sipe is disposed in each block having a pair of opposing corners with acute angles, comparative examples 1 to 5 and embodiments 1 to 3 were made where average distances X_{U}, X_{L} between a contour line of a sipe bottom part projected on a tread surface and a contour line of a sipe upper edge part, and block edge lengths Lᵤ, L_{L}, and distances l_{U}, l_{L} from corners of the block trailing in the side to an opening end of the sipe bottom part were varied as shown in Table 1.

For these test tires, braking performance and block breaking-off were evaluated by the following method, and a result is shown in TABLE 1.

Braking Performance (ABS Braking Stop Distance):

A test tire worn by 50% was attached to a JATMA standard rim, fixed to a vehicle (equipped with ABS) of 2000 cc displacement with air pressure set to 200 kPa, and ran on a wet road of a water depth of 2 mm. Then, a stop distance from a running state of initial speed of 100 km/h until a stopping state was measured. This stop distance was measured five times for each test tire, and an average value among the three measurements excluding maximum and minimum values was obtained. A result of the evaluation is indicated by using an inverse number of the average value of the stop distances and an index when an index of the comparative example 1 (a conventional tire) is set to 100. A larger index value means higher braking performance.

### Block Breaking-Off

After the measurement of the braking stop distance described above, a visual examination was performed to check whether the breaking-off of a block end was present or not.

TABLE 1

| | | | | | Breaking | |
|---|---|---|---|---|---|---|
| | | | | | performance | |
| | | | | | at 50% | Block |
| | | | | | wearing | breaking |
| | X_{L} | X_{U} | l_{L}/L_{L} | lᵤ/L_{U} | (Index) | off |
| Comparative | 0 | 0 | 0.5 | 0.5 | 100 | No |
| example 1 | | | | | | |
| Comparative | 1.5 | 4.0 | 0.38 | 0.18 | 103 | Yes |
| example 2 | | | | | | |
| Comparative | 4.0 | 4.0 | 0.82 | 0.18 | 109 | Yes |
| example 3 | | | | | | |
| Embodiment 1 | 3.75 | 3.75 | 0.8 | 0.2 | 110 | No |
| Embodiment 2 | 5.63 | 1.88 | 0.8 | 0.5 | 105 | No |
| Comparative | 4.0 | 1.5 | 0.82 | 0.62 | 102 | Yes |
| example 4 | | | | | | |
| Embodiment 3 | 1.88 | 5.63 | 0.5 | 0.2 | 106 | No |
| Comparative | 1.25 | 1.25 | 0.4 | 0.6 | 94 | No |
| example 5 | | | | | | |

As can be understood from Table 1, in each of the embodiments 1 to 3, excellent ABS braking performance was exhibited on the wet road in a state of 50% wearing, and no block breaking-off occurred. On the other hand, in each of the comparative examples 1 to 5, a dimension condition on a sipe was not satisfied, and thus it was impossible to improve ABS braking performance and to prevent block breaking-off simultaneously.

According to the present invention, in the pneumatic tire in which at least one sipe is disposed in the block, the sipe length is made gradually longer from the tread surface toward the sipe bottom part and, assuming that the block is equally divided by the boundary of the straight line parallel to the tire circumferential direction into the region U where the corner of the block in the trailing side has an acute angle and the region L where the corner of the block in the leading side has an acute angle, the edge lengths L_{U}, L_{L} of the block respectively measured along the main groove in the regions U, L, and the distances L_{U}, L_{L} from corners of the block in the trailing side to the opening end of the sipe bottom part respectively measured in the regions U, L are set in the relations of 0.4≦l_{L}/L_{L}≦0.8, 0.2≦l_{U}/L_{U}≦0.6, l_{L}/L_{L}≧l_{U}/L_{U}. Thus, it is possible to improve ABS braking performance on the wet road after being worn while preventing occurrence of block breaking-off or the like.

The preferred embodiment of the present invention has been described in detail. However, it should be understood that various changes, modifications and substitutions can be made without departing from the spirit and the scope of the present invention specified by appended claims.

What is claimed is:

1. A pneumatic tire comprising:
a tread pattern whose rotational direction is specified; and
a block plotted on a tread by main grooves extending in a tire circumferential direction and lateral grooves extending in a tire width direction, the block having a pair of opposing corners with acute angles and including at least one sipe therein,
wherein a length of the sipe is made gradually longer from a tread surface toward a sipe bottom part and, assuming that the block is equally divided by a boundary of a straight line parallel to the tire circumferential direction into a region U where a corner of the block in the trailing side has an acute angle and a region L where a corner of the block in the leading side has an acute angle, edge lengths L_{U}, L_{L} of the block respectively measured along the main groove in the regions U, L, and distances 1_{U}, 1_{L} from corners of the block in the trailing side to an opening end of the sipe bottom part respectively measured in the regions U, L are set in relations of 0.4≦1_{L}/L_{L}≦0.8, 0.2≦1_{U}/L_{U}≦0.6, 1_{L}/L_{L}≧1_{U}/L_{U}.

2. A pneumatic tire according to claim 1, wherein at least one of an average distance X_{U} between a contour line of the sipe bottom part projected on the tread surface and a contour line of a sipe upper edge part in the region U, and an average distance X_{L} between the contour line of the sipe bottom part projected on the tread surface and the contour line of the sipe upper edge part in the region L is set to more than 0 mm.

3. A pneumatic tire according to claim 1, wherein at least one of an average distance X_{U} between a contour line of the sipe bottom part projected on the tread surface and a contour line of a sipe upper edge part in the region U, and an average distance X_{L} between the contour line of the sipe bottom part projected on the tread surface and the contour line of the sipe upper edge part in the region L is set to 7% or more of an edge length of the block.
